(19) United States
(12) Patent Application Publication
(10) Pub. No.: US 2009/0024911 A1
(43) Pub. Date: Jan. 22, 2009

(54) GRAPH DATA VISUALIZATION TOOL

(75) Inventor: MICHAEL RYAN MARGOLIS, San Jose, CA (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: APPLE INC., CUPERTINO, CA (US)

(21) Appl. No.: 12/021,622

(22) Filed: Jan. 29, 2008

Related U.S. Application Data
(60) Provisional application No. 60/887,111, filed on Jan. 29, 2007.

(51) Int. Cl. G06F 17/00; G09G 5/22

(52) U.S. Cl. 715/215; 345/440.1

(57) ABSTRACT

Disclosed herein are systems and methods where a time-stamped graphical parameter is displayed in one portion of a display window with a period of relevance highlighted and textual log entries from one or more of various selected logs corresponding to the highlighted time period are displayed in a second portion of the display window. In one embodiment of the invention, the period of relevance on the graph may be manipulated by using GUI controls. As the period of relevance on the graph is changed, the displayed textual log entries are updated to reflect those entries within the current period of relevance.

### CROSS REFERENCE TO RELATED APPLICATIONS

This application claims priority to Provisional U.S. Patent Application Ser. No. 60/887,111, filed Jan. 29, 2007 which is hereby incorporated by reference in its entirety.

### FIELD OF THE INVENTION

This invention relates to network administration. More specifically, the invention relates to a network administration tool.

### BACKGROUND

Throughout the years, computers have been interconnected to form systems with ever-increasing technical complexity. Current computer networks range from Personal Area Networks (“PANs”) centered on a single person to the Wide Area Networks (“WANs”) and Local Area Networks (“LANs”) that may connect systems on different continents. Any collection of operationally connected computing devices together with the network elements which connect them may be viewed collectively as a system. Alternatively, the collection of network elements themselves may also be viewed as a system. For example, a Storage Area Network (“SAN”) can be a system for enabling servers to store data on various storage devices. A SAN typically includes storage elements, storage devices, computer systems, and control software communicating over a network. A person responsible for maintaining or optimizing a system of network computers such as, for example, a SAN or a LAN, is referred to as a system administrator.

FIG. 1 shows an exemplary SAN. Servers 104 are connected to storage elements including RAID arrays 102, 120 and tape backup 106 by connecting elements such as bridges 110, hubs 114, and switches 112. Servers and storage elements are typically connected according to standards such as Fibre Channel or iSCSI, using elements designed for the standard. Servers 134 are connected to these bridges 110, hubs 114, and switches 112 through WAN 128 so that they may store data remotely. Servers 134 are connected through a WAN 128 to a server 126 connected to the connecting elements. Server 126 is connected to the WAN 128 through firewall 124. Information from any of the system components of FIG. 1 may be sent to controllers 108 and/or 116 for processing by special system administration software.

Due to the complexity of modern computer systems, system administrators have long been using specialized software tools to help them in system administration tasks. These tools often include graphical user interfaces (“GUIs”) for representing information received from system components. Graphs may be used to show a graphical quantitative representation of events occurring over time, and they are often useful to recognize low granularity data trends. System administrators often determine the existence of a problem and the most likely time period in which it has occurred by looking for graphical anomalies.

Logs show a textual representation of events occurring over time and are often used to obtain high granularity information surrounding events during a specific time period. System administrators often determine the cause of a problem by examining logs within the time period in which the problem is thought to have occurred.

FIG. 2A illustrates a graph 200 of the prior art. The graph 200 includes a curve 202 representing CPU usage over time, although many other metrics may be graphed on graph 200. The graph 200 includes data points 204 taken at intervals which are connected by graph segments 206. FIG. 2B illustrates textual log entries 250 of a system log 201 of the prior art. Textual log entries 250 typically include a time-stamp 252 and descriptive text 254.

System administrators often use both logs and graphs to identify system events. For example, a network administrator may identify the existence of an undesirable network condition using a graph. The administrator may then use the graph to determine a relevant time period during which one or more events which may have caused of the condition could have occurred. Using this relevant time period, the system administrator may obtain more detailed information from the system log to discover the cause of the error.

Historically, graph-based tools and log-based tools of system administration tools have operated independently. Independently using both types of tools for a common problem requires switching from one function or application to another and entering data manually, which is an inefficient use of the system administrator's time.

### SUMMARY OF THE INVENTION

Disclosed herein are systems and methods where a time-stamped graphical parameter is displayed in one portion of a display window with a period of relevance highlighted and textual log entries from one or more of various selected logs corresponding to the highlighted time period are displayed in a second portion of the display window. In one embodiment of the invention, the period of relevance on the graph may be manipulated by using GUI controls. As the period of relevance on the graph is changed, the displayed textual log entries are updated to reflect those entries within the current period of relevance.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 shows an exemplary SAN.

FIG. 2A illustrates a graph of the prior art.

FIG. 2B illustrates textual log entries of a system log of the prior art.

FIG. 3 sets forth a block diagram of an exemplary computer.

FIG. 4 illustrates a graphical user interface of a SAN administration tool according to the present invention.

FIG. 5 illustrates a GUI including a merged graph with curves showing CPU usage from two metadata controllers and the system log entries falling in the period of relevance for each controller.

FIG. 6 illustrates a GUI with curve showing CPU usage on a single CPU over time.

FIGS. 7A and 7B show a GUI including a graph with a curve showing CPU usage and log entries from multiple logs with time-stamps falling within the period of relevance.

FIG. 8 illustrates a GUI including a scrollbar widget and tabs for manipulating the period of relevance.

### DETAILED DESCRIPTION OF THE PREFERRED EMBODIMENT

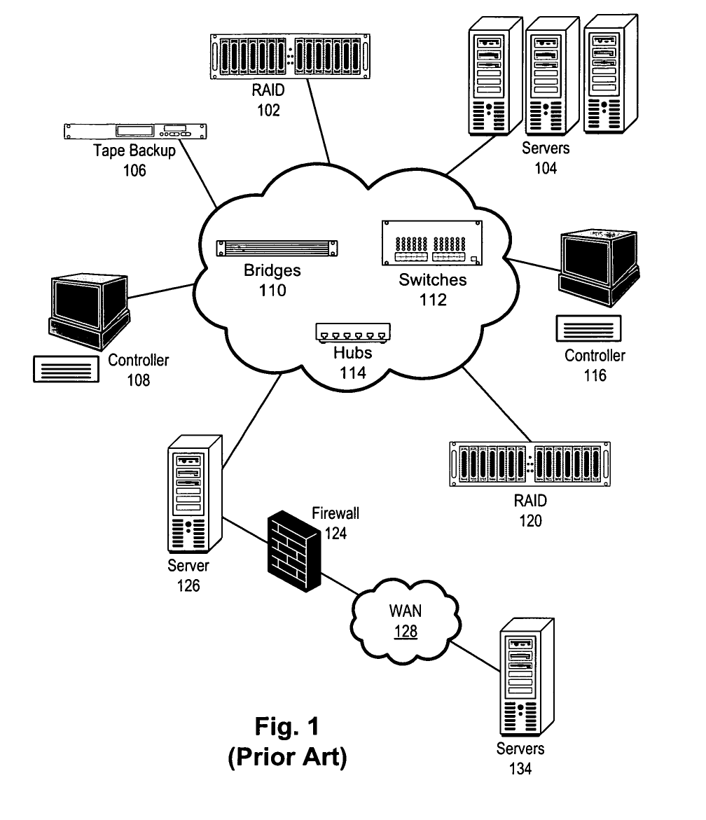

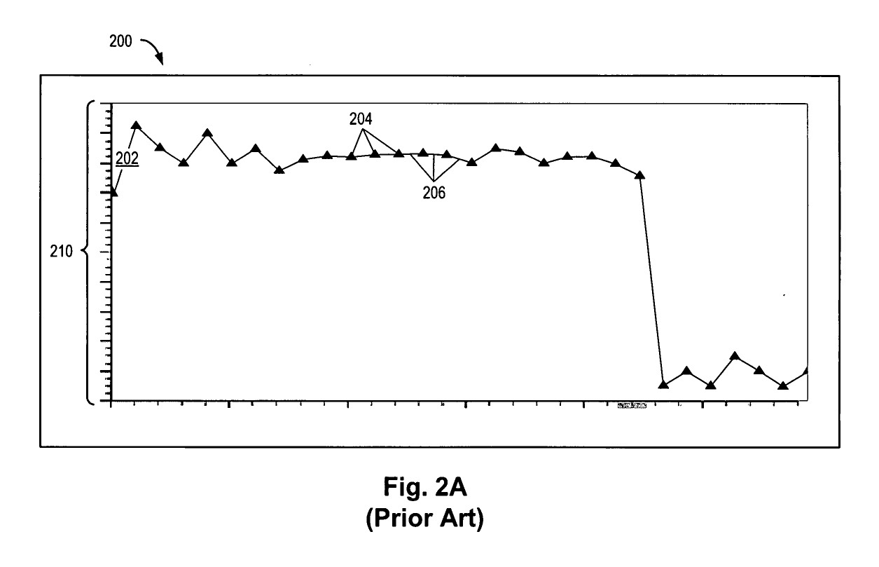

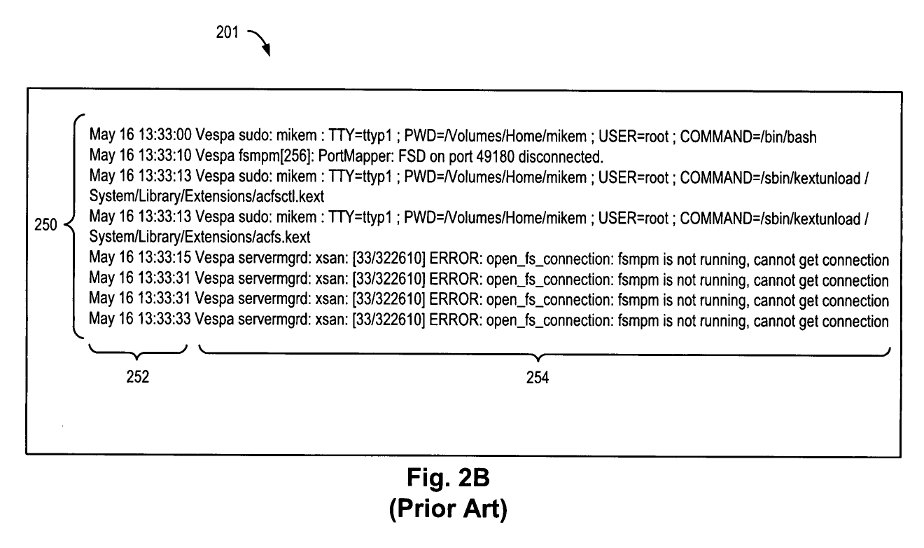

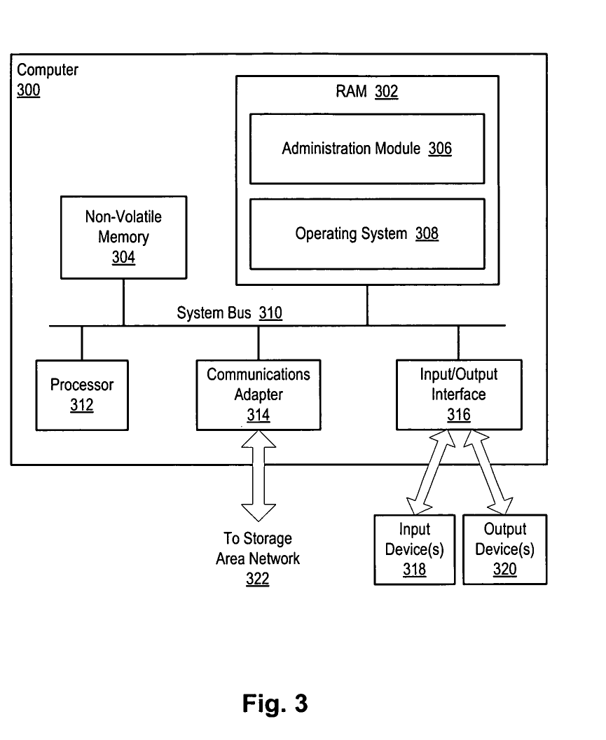

Disclosed herein are methods and systems for system administration. More specifically, the present disclosure includes system administration tools for the simultaneous display and manipulation of graphs and textual log entries. Aspects of the present disclosure are described with reference to the accompanying drawings, beginning with FIG. 3. However, those of skill in the art will appreciate that the detailed description given herein with respect to these figures is for illustrative purposes, as the invention extends beyond these limited embodiments. In some embodiments, the administration tools are for administration of a storage area network such as that of FIG. 1, but are equally applicable to any system of connected computing devices.

Embodiments of the presently disclosed system administration tools are implemented to some extent as software modules installed and running on one or more computers. FIG. 3 sets forth a block diagram of an exemplary computer 300. The computer 300 includes at least one computer processor 312 as well a computer memory, including both volatile random access memory (“RAM”) 302 and some form or forms of non-volatile computer memory 304 such as a hard disk drive, an optical disk drive, or an electrically erasable programmable read-only memory space (also known as ‘EEPROM’ or ‘Flash’ memory). The computer memory is connected through a system bus 310 to the processor 312 and to other system components. Thus the software modules are program instructions stored in computer memory.

An operating system 308 is also stored in computer memory. Also stored in computer memory is an administration module 306, computer program instructions for performing system administration tasks. In controllers 108 and 116, the administration module 306 may include program instructions for requesting and receiving data from other system components such as servers 104, 132, 134, firewalls 118 and 124, the RAID arrays 102 and 120, bridges 110, switches 112, hubs 114, and so on. The administration module 306 processes this data for display through a graphical user interface (“GUI”). The administration module 306 of other system components may include program instructions for sending data to controllers 108 and 116. A log is typically maintained in the administration module 306 of controllers 108 and 116 using the data sent from the other system components, although a log may be maintained in the administration module of the other system components or retrieved from an existing log on these components. Log data may then be sent to the administration module 306 in controllers 108 and 116.

Computer 300 also includes one or more input/output interface adapters 316. Input/output interface adapters 316 may implement user-oriented input/output through software drivers and computer hardware for controlling output to output devices 320 such as computer display screens, as well as user input from input devices 318 such as keyboards and mice.

Computer 300 also includes a communications adapter 314 for implementing data communications with other computers in the Storage Area Network 322. Communications adapter 314 implements the hardware level of data communications through which one computer sends data communications to another computer, directly or through a network. Typical modes of connection include Fibre Channel and Ethernet.

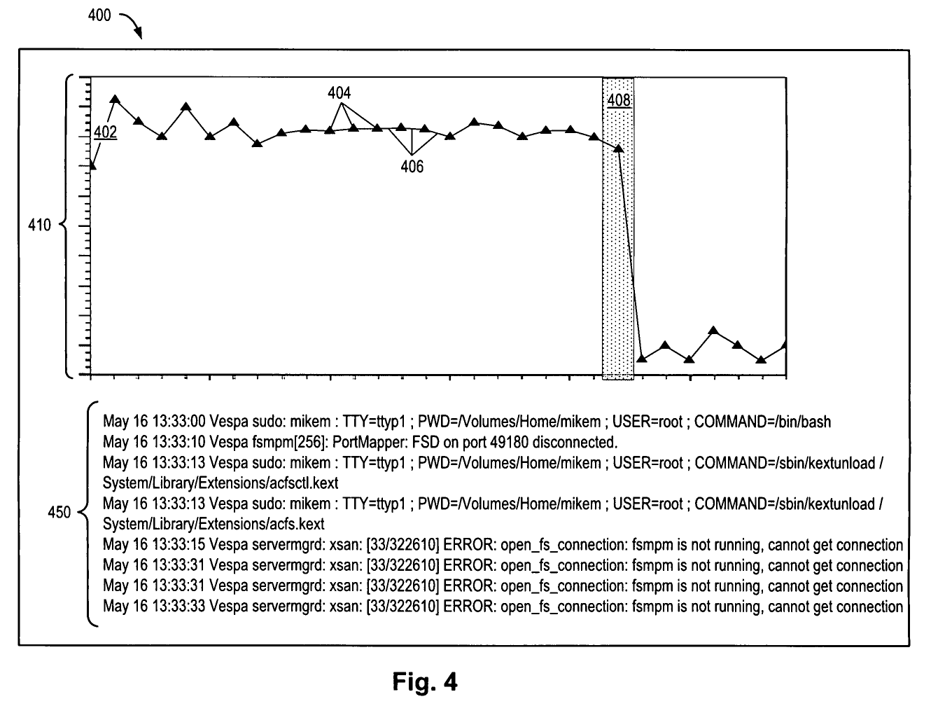

FIG. 4 illustrates a graphical user interface (“GUI”) 400 of a SAN administration tool according to the present invention. The GUI 400 includes a graph 410 with a curve 402 representing CPU usage over time and a period of relevance 408 highlighted in one portion of the display window and textual log entries 450 from a system log corresponding to the highlighted time period in a second portion of the display window. The graph 410 includes data points 404 taken at intervals which are connected by graph segments 406. The period of relevance 408 is a period of time selected from the time period displayed by the graph 410 by the user for a more detailed analysis. The user has selected this period because it contains a conspicuous decline in CPU usage from a steady state to almost zero. The period of relevance 408 is delineated on graph 410 by highlighting. Highlighting, as defined here, includes displaying the period of relevance 408 according to a different scheme than the remainder of the graph, e.g., portraying it as a shape, presenting it with a different background color, data point color, line color, etc. In other implementations, markers may be displayed on the graph at the beginning and end times. Textual log entries 450 time-stamped with a time within the period of relevance 408 are displayed below the graph. These entries indicate that within the period of relevance 408, a user became root and stopped the file system without restarting it. The user may use this information to deduce that this event is the likely cause of the decline in CPU usage.

Although the entries of FIG. 4 are from a system log, entries from any other log could also be displayed. Other exemplary logs include crash logs, console logs, or proprietary logs such as those used for directory systems or servers. Likewise, although a graph of CPU usage is illustrated and described throughout, the present invention is applicable to any time-stamped system parameter. In the case of a SAN, for example, the parameter could be Fibre Channel traffic, Ethernet throughput, disk usage, number of connected users, connections per second, number of predefined events per minute, or a combination of these.

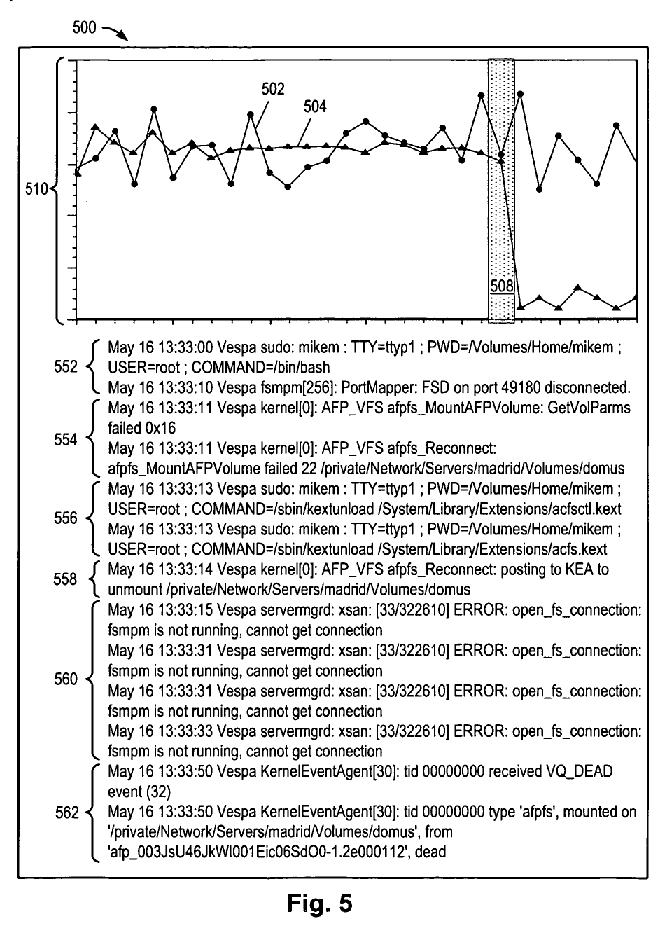

FIG. 5 illustrates a GUI 500 including a merged graph 510 with curves 502, 504 showing CPU usage from two metadata controllers and the system log entries 552, 554 556, 558, 560, 562 falling in the period of relevance 508 for each controller. The two curves 502, 504 are displayed in different colors and with different symbols to better distinguish them. Distinguishing the curves could also be carried out with different line types, line widths, and so on. Similarly, the system log entries for the first controller 552, 556, 560 and the second controller 554, 558, 562 are displayed using different colors. In the present embodiment, the display color for the system log entries 552, 556, 560 and the curve 504 for the first controller is the same. The display colors for the system log entries 554, 558, 562 and the curve 502 for the second controller are identical to each other, but different than that of the first controller.

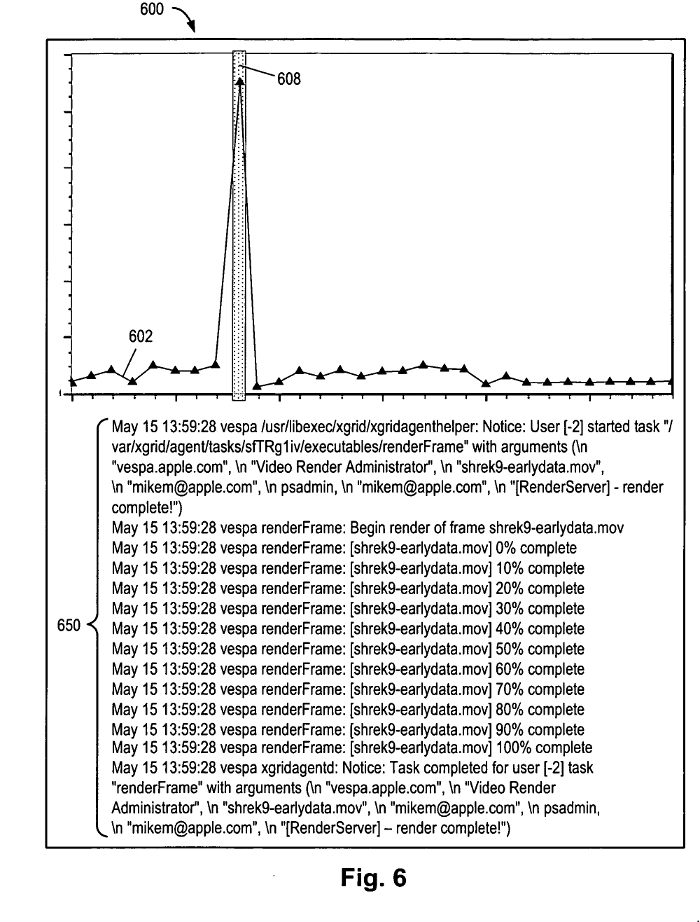

FIG. 6 illustrates a GUI 600 with curve 602 showing CPU usage on a single CPU over time. The graph shows a period of relevance 608 selected by the user because it contains an anomalous increase in CPU usage. Textual log entries 650 time-stamped with a time within the period of relevance 608 are displayed below the graph. These entries indicate that within the period of relevance 608, the CPU began rendering a frame. The user may use this information to deduce that this event is this event is the likely cause of the increase in CPU usage.

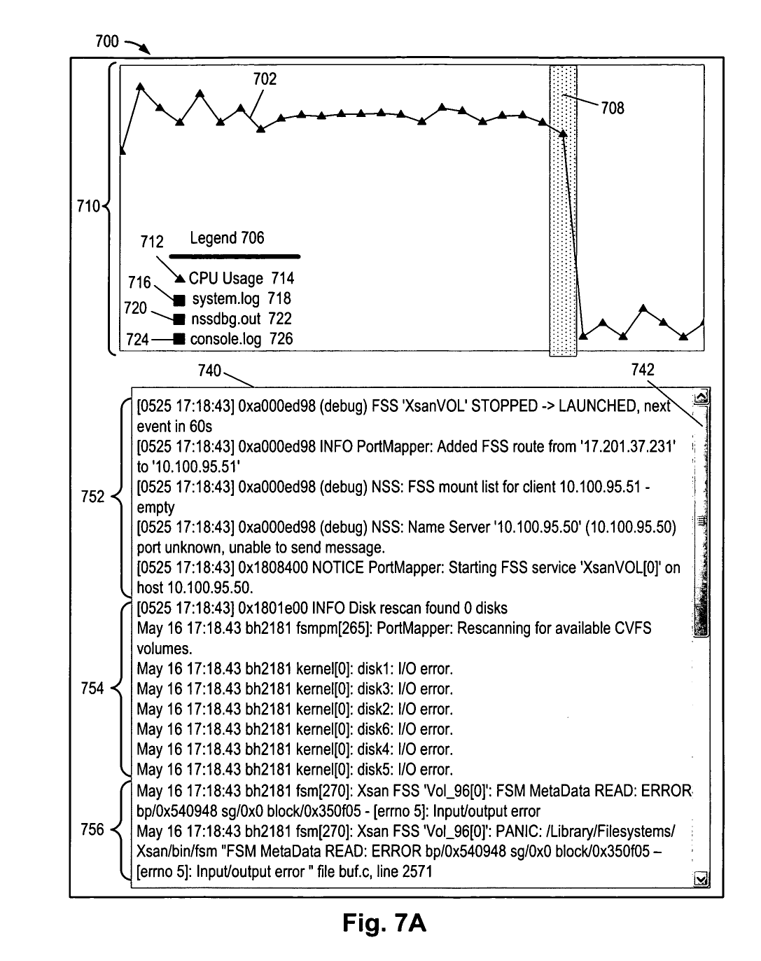

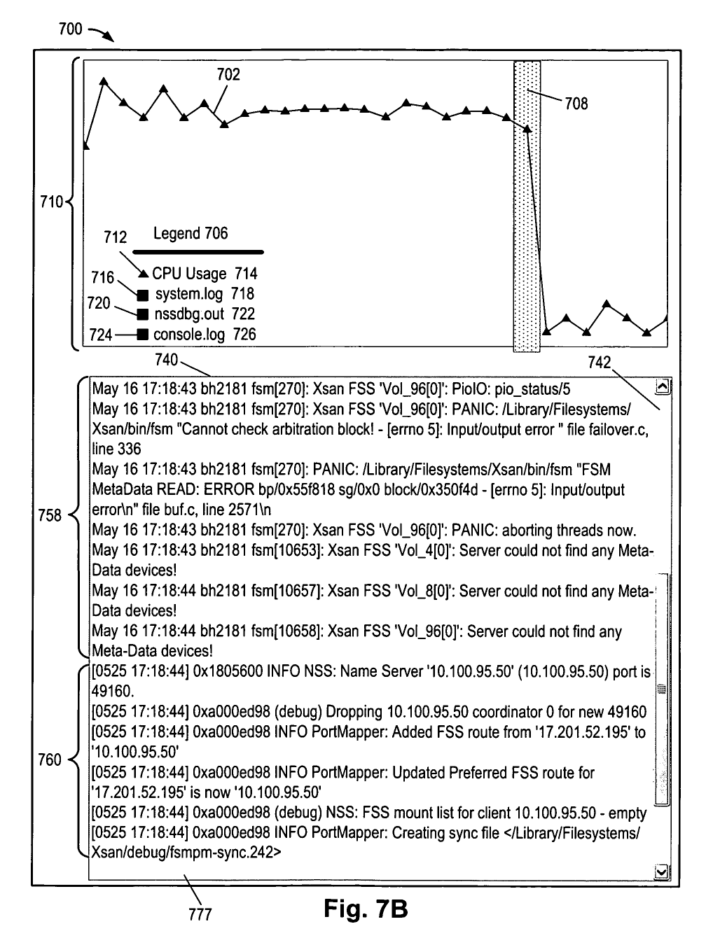

FIGS. 7A and 7B show a GUI 700 including a graph 710 with a curve 702 showing CPU usage and log entries 752, 754, 756, 758, and 760 from multiple logs with time-stamps falling within the period of relevance 708. The log entries 752, 754, 756, 758, and 760 from each log are displayed using a color distinct to that log, as is the curve 702. Log entries 754, 760 from the system log are displayed in green font. Log entries 752, 758 from the log “nssdbg.out” are displayed in red font. Log entries 756 from the console log are displayed in purple font. Curve 702 is displayed in blue.

Often, more log entries fall within the period of relevance 708 than can be displayed on the screen at one time with the configured display parameters. GUI 700 therefore initially displays an initial set of entries in a window 740 in an initial view (FIG. 7A). GUI 700 includes a vertical scroll bar 742. Those entries 758, 760 not initially displayed in a first view (FIG. 7A) may be viewed upon the user's employing the vertical scroll bar to scroll down entries in window 740 to view another subsequent view, such as that shown in FIG. 7B. The entries are typically ordered according to one or more criteria and displayed with the first entries at the top of the display window and the last entries at the bottom. Ordering may be carried out according to any criteria. For example, the entries may be ordered according to timestamp, with the most recent timestamp first (as in FIGS. 7A and 7B) or the least recent timestamp first. The entries may also be ordered according to the particular log from which an entry was produced, or according to any other criteria that may occur to one of skill in the art. In some implementations, entries may be divided into separate windows according to the particular logs from which they are produced.

Graph 710 includes a legend 706 identifying the log or graphed parameter associated with each color used in the GUI 710. Legend 706 identifies the graphed parameter corresponding to the color blue by juxtaposing a key symbol 712 identical in color and shape to the data points in curve 702 and a parameter identifier 714 identifying the parameter “CPU Usage.” Legend 706 identifies the log corresponding to each font color by juxtaposing a log identifier 318, 322, 326 identifying each log type and a color swatch 716, 720, 724 identical in color to the corresponding entries 752, 754, 756, 758, 760.

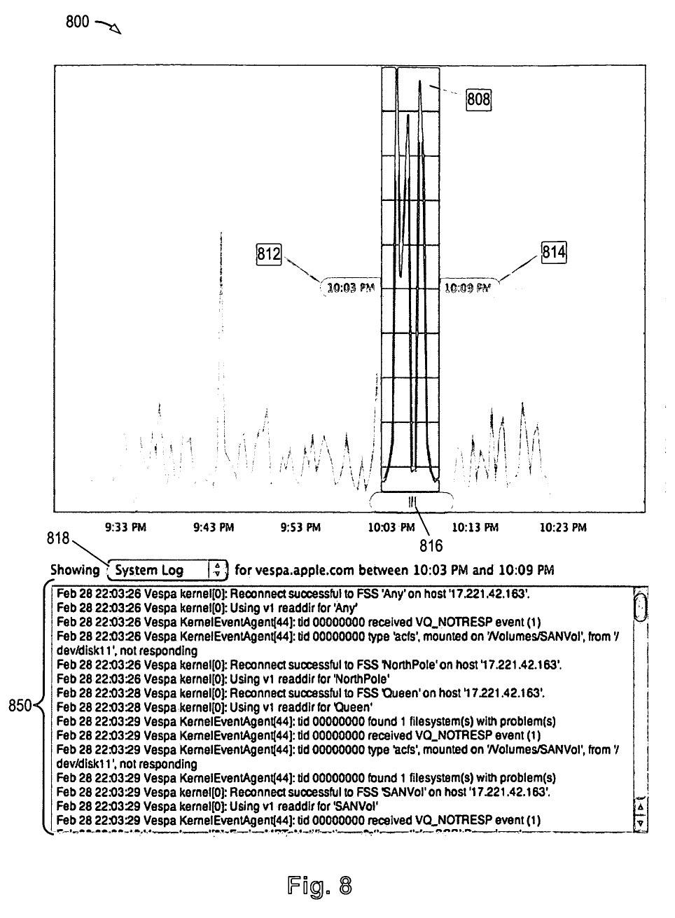

FIG. 8 illustrates a GUI 800 including a scrollbar widget 816 and tabs 812, 814 for manipulating the period of relevance 808. The user may “slide” the period of relevance across the graph to a desired location by clicking and dragging the scrollbar widget 816 horizontally along the graph in either direction. In this operation, the length of time for the period of relevance 808 does not change, though the beginning and ending times do. The user may change the start or end time individually by clicking and dragging either the beginning time tab 812 or the end time tab 814. This operation has the effect of changing the length of time for the period of relevance 808, and thus changing the width on the graph of the period of relevance 808 and the scrollbar widget 816. In one embodiment, the current beginning time and end time, in configurable granularity, are displayed within the beginning time tab 812 and the end time tab 814, respectively. In some embodiments, the period of relevance 808, the scrollbar widget 816, and tabs 812, 814 are displayed immediately upon GUI initiation, while in others, they may be initiated by a user clicking and dragging a mouse cursor across the screen, by a combination of keystrokes, and so on. In some implementations, as the period of relevance on the graph is changed, the displayed textual log entries are updated to reflect those entries within the current period of relevance.

It should be understood that the inventive concepts disclosed herein are capable of many modifications. To the extent such modifications fall within the scope of the appended claims and their equivalents, they are intended to be covered by this patent.

What is claimed is:

1. A method for presenting system administration data in a display window on a display element, the method comprising the steps of:
displaying a graph of one or more system parameters over time in one portion of the display window;
highlighting a period of relevance within said graph; and
displaying in a second portion of the display window textual log entries corresponding to said period of relevance from one or more logs.

2. The method of claim 1 further comprising:
presenting an interface for designating said period of relevance highlighted on said graph; and
accepting input from said interface to designate a period of relevance, wherein highlighting said period of relevance within said graph is done according to said input.

3. The method of claim 2 wherein:
said input designates an updated period of relevance;
highlighting said period of relevance within said graph according to said input comprises highlighting said updated period of relevance; and
displaying in a second portion of the display textual log entries corresponding to said period of relevance from one or more logs further comprises displaying log entries corresponding to said updated period of relevance.

4. The method of claim 2 wherein:
said period of relevance has a beginning time and an ending time; and
said interface comprises a graphic user interface (“GUI”) element adapted to identically alter said beginning time and said ending time.

5. The method of claim 4 wherein said GUI element is a scroll bar.

6. The method of claim 2 wherein said interface comprises a GUI element for altering said beginning time independently.

7. The method of claim 2 wherein said interface comprises a GUI element for altering said ending time independently.

8. The method of claim 1 wherein displaying in a second portion of the display textual log entries corresponding to said period of relevance from one or more logs comprises displaying textual log entries from each log in a distinct color.

9. The method of claim 8 further comprising:
displaying on the display a legend indicating said color in which each log's textual log entries are displayed.

10. The method of claim 1 wherein displaying a graph of one or more system parameters over time in one portion of the display window comprises displaying a graph of a plurality of system parameters with a curve of a distinct color for each system parameter.

11. The method of claim 10 further comprising displaying on the display a legend indicating said color in which each parameter's curve is displayed.

12. The method of claim 10 wherein:
one or more system parameters correspond to one or more logs; and
displaying in a second portion of the display textual log entries corresponding to said period of relevance from one or more logs comprises displaying textual log entries in a distinct color identical to said color in which said curve is displayed for said corresponding system parameter.

13. The method of claim 12 further comprising:
displaying a legend indicating said color in which each log's textual log entries are displayed.

14. A system for presenting system administration data in a display window of a display element comprising:
a processor;
an input/output interface operatively coupled to said processor;
an input device and a display element operatively coupled to said input/output interface; and
a computer memory operatively coupled to said processor, the computer memory having stored therein log entries from one or more logs containing information from at least one system component and values of system parameters from a multiplicity of times, and disposed therein computer program instructions for
displaying a display window on the display element;
displaying a graph of values of one or more system parameters over time in one portion of the display window;
highlighting a period of relevance within said graph; and
displaying in a second portion of the display window textual log entries corresponding to said period of relevance from one or more logs.

15. The system of claim 14 wherein:
said computer memory further has disposed therein computer program instructions for accepting input from said input/output interface to designate a period of relevance; and
said computer program instructions for highlighting a period of relevance within said graph comprise computer program instructions for highlighting said period of relevance within said graph according to said input.

16. The system of claim 15 wherein:
said input designates an updated period of relevance;
said computer program instructions for highlighting said period of relevance within said graph according to said input comprise computer program instructions for highlighting said updated period of relevance; and
said computer program instructions for displaying in a second portion of the display textual log entries corresponding to said period of relevance from one or more logs further comprise computer program instructions for displaying log entries corresponding to said updated period of relevance.

17. The system of claim 15 wherein:
said computer memory further has disposed therein computer program instructions for presenting a graphical user interface (“GUI”) for designating said period of relevance highlighted on said graph, said GUI including a graphical element displayed on the display element for manipulation by a user through said input device; and
said computer program instructions for accepting input from said input/output interface to designate a period of relevance comprise computer program instructions for accepting input corresponding to said GUI from said input/output interface to designate a period of relevance, said input being sent to said input/output interface from said input device.

18. The system of claim 17 wherein:
said period of relevance has a beginning time and an ending time;
said GUI comprises a GUI element adapted to individually alter said beginning time and said ending time; and
said computer program instructions for highlighting said period of relevance within said graph according to said input comprise said computer program instructions for individually altering said beginning time and said ending time.

19. The system of claim 17 wherein:
said period of relevance has a beginning time and an ending time;
said GUI comprises a GUI element adapted to identically alter said beginning time and said ending time; and
said computer program instructions for highlighting said period of relevance within said graph according to said input comprise computer program instructions for identically altering said beginning time and said ending time.

20. The system of claim 19 wherein said GUI element is a scroll bar.

21. The system of claim 14 wherein said computer program instructions for displaying in a second portion of the display textual log entries corresponding to said period of relevance from one or more logs comprises displaying textual log entries from each log in a distinct color.

22. The system of claim 21 wherein said computer memory further has disposed therein computer program instructions for displaying on the display a legend indicating said color in which each log's textual log entries are displayed.

23. The system of claim 14 wherein said computer program instructions for displaying a graph of one or more system parameters over time in one portion of the display window comprise computer program instructions for displaying a graph of a plurality of system parameters with a curve of a distinct color for each system parameter.

24. The system of claim 23 wherein said computer memory further has disposed therein computer program instructions for displaying on the display a legend indicating said color in which each parameter's curve is displayed.

25. The system of claim 23 wherein:
one or more system parameters correspond to one or more logs; and
said computer program instructions for displaying in a second portion of the display textual log entries corresponding to said period of relevance from one or more logs comprise said computer program instructions for displaying textual log entries in a distinct color identical to said color in which said curve is displayed for said corresponding system parameter.

26. The system of claim 14 wherein said computer memory further has disposed therein computer program instructions for displaying a legend indicating said color in which each log's textual log entries are displayed.

27. A computer program product embodied on a computer-readable medium for presenting in a display window of a display element computer program product administration data from values of computer program product parameters and log entries stored in a computer memory, comprising computer program instructions for:
displaying a display window on a display element;
displaying a graph of values of one or more computer program product parameters over time in one portion of the display window;
highlighting a period of relevance within said graph; and
displaying in a second portion of the display window textual log entries corresponding to said period of relevance from one or more logs.

28. The computer program product of claim 27 further comprising computer program instructions for accepting input from an input/output interface to designate a period of relevance, wherein said computer program instructions for highlighting said period of relevance within said graph comprise computer program instructions for highlighting said period of relevance within said graph according to said input.

29. The computer program product of claim 28 wherein:
said input designates an updated period of relevance;
said computer program instructions for highlighting said period of relevance within said graph according to said input comprise computer program instructions for highlighting said updated period of relevance; and
said computer program instructions for displaying in a second portion of the display textual log entries corresponding to said period of relevance from one or more logs further comprise computer program instructions for displaying log entries corresponding to said updated period of relevance.

30. The computer program product of claim 28 further comprising computer program instructions for presenting a graphical user interface (“GUI”) for designating said period of relevance highlighted on said graph, said GUI including a graphical element for display on the display element for manipulation by a user through an input device, wherein said computer program instructions for accepting input from an input/output interface to designate a period of relevance comprise computer program instructions for accepting input corresponding to said GUI originating from said input device to designate a period of relevance.

31. The computer program product of claim 30 wherein:
said period of relevance has a beginning time and an ending time;
said GUI comprises a GUI element adapted to individually alter said beginning time and said ending time; and
said computer program instructions for highlighting said period of relevance within said graph according to said input comprise said computer program instructions for individually altering said beginning time and said ending time.

32. The computer program product of claim 30 wherein:
said period of relevance has a beginning time and an ending time;
said GUI comprises a GUI element adapted to identically alter said beginning time and said ending time; and
said computer program instructions for highlighting said period of relevance within said graph according to said input comprise computer program instructions for identically altering said beginning time and said ending time.

33. The computer program product of claim 32 wherein said GUI element is a scroll bar.

34. The computer program product of claim 27 wherein said computer program instructions for displaying in a second portion of the display textual log entries corresponding to said period of relevance from one or more logs comprises displaying textual log entries from each log in a distinct color.

35. The computer program product of claim 34 further comprising computer program instructions for displaying on the display a legend indicating said color in which each log's textual log entries are displayed.

36. The computer program product of claim 27 wherein said computer program instructions for displaying a graph of one or more computer program product parameters over time in one portion of the display window comprise computer program instructions for displaying a graph of a plurality of computer program product parameters with a curve of a distinct color for each computer program product parameter.

37. The computer program product of claim 36 further comprising computer program instructions for displaying on the display a legend indicating said color in which each parameter's curve is displayed.

38. The computer program product of claim 36 wherein:
one or more computer program product parameters correspond to one or more logs; and
said computer program instructions for displaying in a second portion of the display textual log entries corresponding to said period of relevance from one or more logs comprise computer program instructions for displaying textual log entries in a distinct color identical to said color in which said curve is displayed for said corresponding computer program product parameter.

39. The computer program product of claim 27 further comprising computer program instructions for displaying a legend indicating said color in which each log's textual log entries are displayed.
